(19) United States
(12) Patent Application Publication
(10) Pub. No.: US 2009/0003646 A1
(43) Pub. Date: Jan. 1, 2009

(54) LOSSLESS VISIBLE WATERMARKING

(75) Inventors: Oscar Chi Lim Au, Kowloon (HK); Shu Kei Yip, Kowloon (HK)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Kowloon (HK)

(21) Appl. No.: 11/771,663

(22) Filed: Jun. 29, 2007

(51) Int. Cl. G06K 9/00

(52) U.S. Cl. 382/100

(57) ABSTRACT

Systems and methodologies for lossless visible watermarking of images are provided herein. The provided systems and methodologies can utilize a Pixel Value Mapping Algorithm (PVMA), wherein a watermark can be embedded into an image by transforming respective intensities of areas of the image corresponding to the watermark using a bijective mapping function. Additionally and/or alternatively, a Pixel Position Shift Algorithm (PPSA) can be used to embed a watermark into an image by shifting the position of pixels in the image corresponding to the watermark over a specified shift distance. Further, provided systems and methodologies can facilitate enhanced watermarking security by embedding a visible watermark into an image based on a secret key.

### TECHNICAL FIELD

The subject invention relates generally to image processing, and more particularly to lossless techniques for embedding a visible watermark into an image.

### BACKGROUND OF THE INVENTION

Digital watermarking techniques are often used to establish ownership and authenticity of media objects such as images. Conventionally, both visible watermarking and invisible watermarking techniques are used for embedding watermark information into images. Visible watermarks are perceptually visible to a viewer of an image or other media object in which the watermark is embedded. Such watermarks can be used for deterrence against theft, diminishing the commercial value of an image without diminishing its utility, discouraging the unauthorized reproduction of an image, identification of the source of an image, and/or other uses. In contrast, invisible watermarks are perceptually transparent to a viewer and are primarily used for authentication of images and other media.

In traditional visible watermarking and invisible watermarking techniques, watermarking is performed by embedding a digital watermark signal into a digital host signal, such as a host image, to obtain a watermarked signal. However, most traditional watermarking techniques introduce distortion into the host image during the embedding process, which results in a permanent peak signal-to-noise ratio (PSNR) loss in the host image. As a result, most traditional watermarking techniques cannot be applied in medical, military, and/or applications that are sensitive to embedding distortion and prohibit permanent loss of signal fidelity. A lossless, reversible watermarking scheme is required for such applications, where the original host signal can be perfectly recovered upon extracting the watermark from the host signal. While lossless watermarking algorithms exist for invisible watermarking, those schemes are not applicable to visible watermarking due to the different objectives of visible and invisible watermarking and the fact that visible watermarking typically causes greater distortion than invisible watermarking. Accordingly, there exists a need for effective lossless techniques for visible watermarking.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides systems and methodologies for lossless visible watermarking of images. In particular, a Pixel Value Mapping Algorithm (PVMA) and/or a Pixel Position Shift Algorithm (PPSA) can be utilized to embed a visible watermark into an image such that the image can later be restored without distortion by extracting the watermark from the image. In accordance with one aspect, the PVMA can be used to embed a watermark into an image by transforming areas of the image corresponding to the watermark using a bijective mapping function. Additionally and/or alternatively, the PPSA can be used to embed a watermark into an image by shifting the position of pixels in the image corresponding to the watermark over a specified shift distance. Upon receiving an image watermarked using the PVMA and/or PPSA, an inverse mapping function and/or a reverse position shift can be respectively utilized to perfectly remove the watermark from the image, resulting in the reconstruction of the original image without distortion.

In accordance with another aspect, the PVMA can provide added security by utilizing a bijective mapping function based on a secret key. The secret key may be used, for example, to generate an offset for each pixel to be transformed. This offset can then be incorporated into the mapping function to embed a watermark into an image. As a result, the secret key can be required for complete extraction of the watermark from the image. This can be used, for example, to prevent unauthorized parties from extracting a watermark.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a system for processing and communicating an image in accordance with an aspect of the present invention.

FIG. 2 is a block diagram of a system for watermarking an image in accordance with an aspect of the present invention.

FIG. 3 illustrates circular representations of value mapping functions that may be used for visible watermarking in accordance with an aspect of the present invention.

FIG. 4 illustrates an example circular shifting operation in accordance with an aspect of the present invention.

FIG. 5 is a block diagram of a system for securely embedding a visible watermark in an image in accordance with an aspect of the present invention.

FIG. 6 illustrates an example watermark and an image in which the watermark can be embedded in accordance with an aspect of the present invention.

FIGS. 7-8 illustrate examples of watermarked images in accordance with various aspects of the present invention.

FIG. 9 is a flowchart of a method of embedding and extracting a visible watermark in accordance with an example of the present invention.

FIG. 10 is a flowchart of a method of embedding a visible watermark in an image in accordance with an example of the present invention.

FIG. 11 is a flowchart of a method of securely watermarking an image in accordance with an example of the present invention.

FIG. 12 is a block diagram of an example operating environment in which the present invention may function.

FIG. 13 is a block diagram of an example networked computing environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The components may communicate via local and/or remote processes such as in accordance with a signal having one or more data packets (e.g., data from one component interacting with another component in a local system, distributed system, and/or across a network such as the Internet with other systems via the signal).

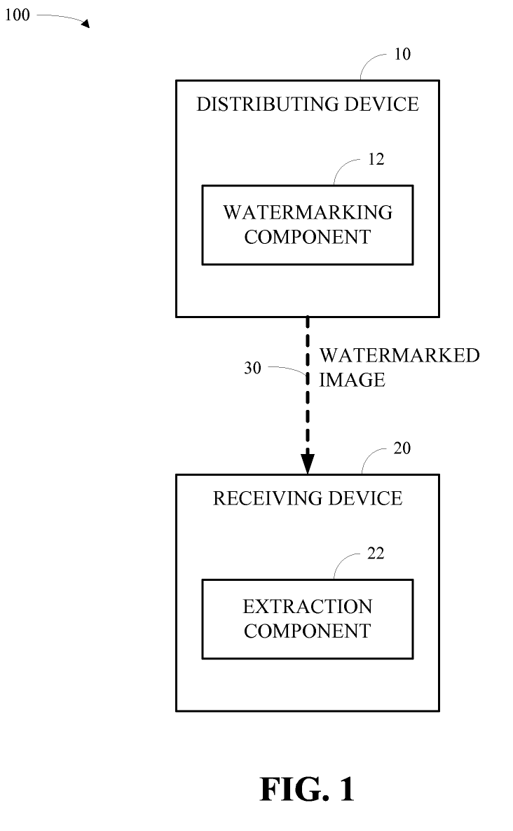

Referring to the drawings, FIG. 1 illustrates a high-level block diagram of a system 100 for processing and communicating an image in accordance with an aspect of the present invention. In one example, system 100 includes a distributing device 10 that can transmit images and other media objects to a receiving device 20. While only one receiving device 20 is illustrated in system 100 for simplicity, it should be appreciated that system 100 can include any number of receiving devices 20. In another example, a watermarking component 12 can create a watermarked image 30 for distribution to the receiving device 20 by embedding a visible watermark in an original image. While the watermarking component 12 is illustrated in FIG. 1 as part of the distributing device 10, it should be appreciated that the watermarking component 12 may alternatively be external to the distributing device 10 and externally provide watermarked images 30 to the distribution device 10 for subsequent distribution to a receiving device 20. In one example, a watermark used by the watermarking component 12 can be internally generated by the watermarking component 12 or provided to the watermarking component 12 by an external entity. Further, an original image from which the watermarking component 12 can create a watermarked image 30 can be provided by the distributing device 10 or any other appropriate media-providing entity.

Additionally and/or alternatively, the watermarking component 12 can receive a video sequence from the distributing device 10 or another media-providing entity. The watermarking component 12 can process some or all of the frames in the video sequence as a series of original images, for which the watermarking component 12 can generate corresponding watermarked images 30. The watermarking component 12 and/or the distributing device 10 can then replace original frames in the video sequence with respective watermarked frames to facilitate transmission of a watermarked video signal to the receiving device 20.

To facilitate the communication of watermarked images 30 from the distributing device 10 and the receiving device 20, the devices can be communicatively connected via a wired (e.g., Ethernet, IEEE-802.3, etc.) or wireless (IEEE-802.11, Bluetooth™, etc.) networking technology. Additionally, distributing device 10 and receiving device 20 can be directly connected to one another or indirectly connected through a third party device (not shown). For example, distributing device 10 can be a Web server that provides media content and a receiving device 20 can be a client computer that accesses distributing device 10 over the Internet via an Internet service provider (ISP). As another example, a receiving device 20 can be a mobile terminal that accesses media content from distributing device 10 via a cellular communications network such as the Global System for Mobile Communications (GSM), a Code Division Multiple Access (CDMA) communication system, and/or another suitable cellular communications network.

In accordance with one aspect, the watermarking component 12 can embed a visible watermark into an original image via one or more lossless watermarking algorithms. For example, the watermarking component 12 can utilize a Pixel Value Mapping Algorithm (PVMA) to transform areas of an image corresponding to a watermark to be embedded in the image using a bijective value mapping function. Additionally and/or alternatively, the watermarking component 12 can utilize a Pixel Position Shift Algorithm (PPSA) to perform a circular pixel shift on areas of an image corresponding to a watermark to be embedded in the image. By utilizing lossless visible watermarking, the watermarking component 12 can achieve the objectives of visible watermarking while mitigating the deficiencies of conventional lossy watermarking techniques. For example, the ownership of a given watermarked image 30 can be made easily ascertainable, which is generally not possible for invisibly watermarked images, without the permanent loss of image signal fidelity generally associated with lossy visible watermarking techniques. As a result, the watermarking component 12 can be utilized to visibly watermark images for medical, military, and/or other applications that are intolerant to image distortion. Similarly, the watermarking component 12 can be utilized by media providers to freely provide images with embedded watermarks that can later be removed to perfectly reconstruct the original image upon payment of a monetary fee.

In accordance with another aspect, the PVMA, PPSA, and/or other lossless watermarking algorithms utilized by the watermarking component 12 can take properties of human vision and practical considerations into account to provide effective and visually pleasing watermarked images 30. For example, regions of an image with uniform intensity (e.g., smooth regions) are generally perceived with more sensitivity to noise than regions of an image with non-uniform intensity (e.g., textured regions). Accordingly, the watermarking component 12 can apply less strength to an embedded watermark in low-variance or smooth image regions and more strength in high-variance or textured regions, thereby facilitating consistent visibility of a watermark throughout an image. As another example, areas of moderate intensity in an image are generally perceived with more sensitivity to noise than areas of low or high intensity, and as a result the watermarking component 12 can apply less strength to an embedded watermark in mid-intensity image regions and more strength in low- and high-intensity image regions. As an additional example, the watermarking component 10 can embed a watermark in multiple locations in an image and/or near the center of an image to prevent a watermark from simply being cropped out of a watermarked image 30 by a disingenuous user.

Watermarked images generated by the watermarking component 12 can then be received by a receiving device 20, at which an extraction component 22 can extract the watermark from the watermarked image 30 to obtain a recovered image. In one example, information regarding the watermark embedded in the watermarked image 30 can be received by the extraction component 22 from the distributing device 10 and/or another appropriate external entity. Alternatively, because watermarked images 30 can contain visible watermarks, the extraction component 22 can ascertain the watermark to be extracted from a watermarked image 30 from the image itself. In accordance with one aspect, the extraction component 22 can perfectly extract a watermark from a watermarked image 30 to obtain a recovered image that is substantially identical to the original image prior to watermarking by performing the inverse of the PVMA, PPSA, and/or other watermarking algorithms utilized by the watermarking component. The algorithms employed by the watermarking component 12, and by extension the inverse algorithms to be performed by the extraction component 22, can be communicated from the watermarking component 12 to the extraction component 22 or known a priori throughout the system 100.

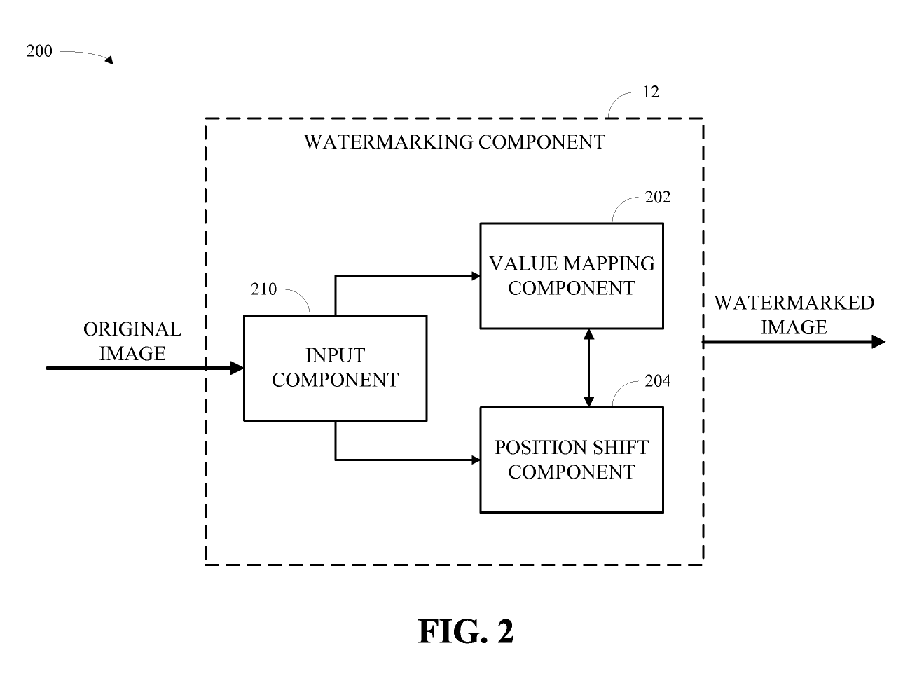

Referring now to FIG. 2, a block diagram of a system 200 for watermarking an image in accordance with an aspect of the present invention is illustrated. In one example, system 200 includes a watermarking component 12 that can utilize one or more lossless watermarking algorithms to embed a visible watermark in an original image to obtain a watermarked image. In one example, the watermarking component 12 can be associated with a distributing device 10 in a similar manner to watermarking component 12 in system 100. The watermark component can include an input component 210 that can receive an original image to be watermarked and/or a watermark to embed in the original image. By way of specific, non-limiting example, the watermarking component 12 can further include a value mapping component 202 that can perform a PVMA on an original image and a position shift component 204 that can perform a PPSA on an original image. While both a value mapping component 202 and a position shift component 204 are illustrated as included in system 200, it should be appreciated that both components need not be utilized by the watermarking component 12. It should be further appreciated that the watermarking component 12 can further perform any other appropriate lossless watermarking algorithms not illustrated by components in system 200 in conjunction with the value mapping component 202 and/or the position shift component 204.

In accordance with one aspect, the watermarking component 12 can apply a visible watermark W to an original image P of size M×N to obtain a watermarked image Q of size M×N. In one example, the watermark W to be embedded in image P can similarly have a size of M×N. A watermark of size M×N can be a standard watermark stored by the watermarking component 12, or alternatively the watermark W can be dynamically created or resized from a pre-stored watermark of a different size. In another example, the watermark W can be a binary watermark that consists of a series of 1-bit values that indicate whether individual pixels in the image P will be transformed upon embedding the watermark in the image, e.g., W(x, y) ∈ {0,1} for x=1, . . . , M and y=1, . . . , N.

Accordingly, the value mapping component 202 and/or the position shift component 204 at the watermarking component 12 may operate according to the following discussion to embed a watermark W into an original image P. While the algorithms employed by said components are herein generally discussed for the spatial domain, it should be appreciated that the algorithms could also be performed in the frequency domain by, for example, performing a discrete cosine transform (DCT) on image P and performing the algorithms with respect to DCT coefficients in the image.

In accordance with one aspect, the value mapping component 202 can employ a Pixel Value Mapping Algorithm (PVMA) as follows. Given an original image P and a binary watermark W of size M×N, the value mapping component 202 can embed watermark W into the original image P to obtain a watermarked image Q using a bijective intensity mapping function ƒ. This can be expressed as follows:

$$Q ( x , y ) = \{ \begin{matrix}f ( P ( x , y ) ) , & if W ( x , y ) = 0 \\ P ( x , y ) , & if W ( x , y ) = 1\end{matrix} , \qquad ( 1 )$$

where W(x, y)=0 when a pixel at location (x, y) is to be transformed by the value mapping component 202 and ƒ(P(x, y)) represents the bijective mapping function ƒ applied at location (x, y) of image P.

The bijective intensity mapping function ƒ can be any function that provides a bi-directional one-to-one mapping between respective pixels of the original image P and the corresponding watermarked image Q. By way of specific, non-limiting example, function ƒ can be a linear mapping function such as one or more of the following:

f(t)=255−t, (2)

f(t, c)=(t+c)mod256, (3)

or a piecewise linear mapping function such as the following example:

$$f ( t ) = \{ \begin{matrix}t , & t > {T}_{1} or t < {T}_{2} \\ {T}_{2} + {T}_{1} - t , & {T}_{1} \geq t \geq {T}_{2}\end{matrix} , \qquad ( 4 )$$

where t ∈ {0, . . . , 255} represents the intensity of a given pixel, c is a user-defined constant, and 255≧T₁≧T₂≧0. In another example, as the mapping function ƒ used to embed watermark W into original image P is bijective, the inverse of ƒ, which can be denoted as ƒ⁻¹, can subsequently be used (e.g., by an extraction component 22) with the help of the watermark W to extract the watermark W from a watermarked image Q to obtain a recovered image R that is substantially identical to the original image P. Subsequent extraction of the watermark W and generation of a recovered image R can accordingly be expressed as follows:

$$R ( x , y ) = \{ \begin{matrix}{f}^{- 1} ( Q ( x , y ) ) , & if W ( x , y ) = 0 \\ Q ( x , y ) , & if W ( x , y ) = 1\end{matrix} . \qquad ( 5 )$$

In accordance with another aspect, the position shift component 204 can employ a Pixel Position Shift Algorithm (PPSA) as follows. In one specific, non-limiting example, the PVMA is performed equally by the value mapping component 202 for low-variance regions and high-variance regions of an original image P. This may lead to inconsistent visibility of the watermark throughout the image, as more energy is generally needed to embed a watermark in a textured image region due to the nature of human vision. As a result, the PPSA performed by the position shift component 204 can include a circular pixel shift of pixels of an original image P corresponding to a binary watermark W in the spatial domain. In one example, a circular pixel shift g can be performed for horizontal watermark regions W(x₁, y) to W(x₂, y) having consecutive values of “0.” The circular pixel shift g can be performed by shifting each pixel in corresponding regions of the original image P to the right using one or more pixel distances d. The circular pixel shift g can be expressed as follows:

g(x, y, d)=P((x−x₁+d)mod(x₂−x₁+1)+x₁,y), (6)

where x={x₁, . . . , x₂}.

By utilizing both the value mapping component 202 and the position shift component 204, a watermarked image Q generated by the watermarking component 12 using both the PVMA and the PPSA can then be expressed as follows:

$$Q ( x , y ) = \{ \begin{matrix}g ( f ( P ( x , y ) ) ) & if W ( x , y ) = 0 \\ P ( x , y ) & if W ( x , y ) = 1\end{matrix} . \qquad ( 7 )$$

For low-variance regions of an original image P, there may be little visible effect after utilizing the position shift component 204 to perform a circular pixel shift. However, for high-variance regions, the circular shift performed by the position shift component 204 can facilitate the embedding of the watermark W with more energy, which can result in a more visible watermark in the watermarked image Q. Further, since a circular pixel shift does not destroy the texture pattern of the original image P, a viewer of the watermarked image Q can still ascertain the texture information of the original image P from the watermarked image. Further, as the circular pixel shift g, like the mapping function ƒ, is bijective, a recovered image R can be perfectly obtained (e.g., by an extraction component 22) from a watermarked image Q constructed according to Equation (7) above by applying an inverse circular pixel shift followed by an inverse intensity mapping function.

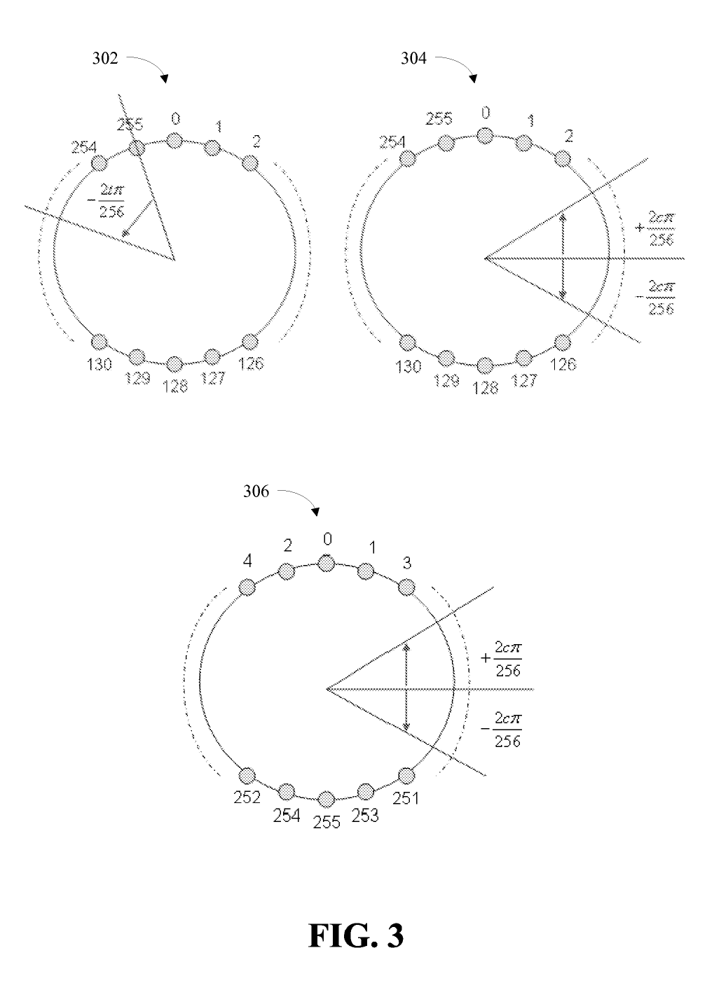

Referring to FIG. 3, circular representations 302-306 of value mapping functions ƒ that may be used for visible watermarking (e.g., by a value mapping component 202 at a watermarking component 12) in accordance with an aspect of the present invention are illustrated. In one example, value mapping performed in accordance with value mapping functions ƒ can be interpreted as the rotation of circular representations 302-306, where intensity values are evenly distributed on each circle 302-306. As used in circular representations 302-206, a positive sign denotes rotation in the clockwise direction while a negative sign denotes rotation in the counterclockwise direction.

In accordance with one aspect, Equations (2) and (3) are respectively illustrated in FIG. 3 by circular representations 302 and 304. As noted supra with regard to system 200, a binary watermark can be embedded into a host image visibly using Equations (2) and (3). However, as can be observed from the corresponding circular representations 302 and 304, Equation (2) may introduce large amounts of distortion into areas of an image that have large or small intensity values. Further, Equation (3) may introduce “salt and pepper” artifacts into the image due to jumping between intensity values of 0 and 255 caused by the modulo operation used in Equation (3). Accordingly, a piecewise linear mapping function, such as the function provided in Equation (4), can be utilized to reduce the appearance of “salt and pepper” artifacts. As illustrated by Equation (4), a piecewise linear mapping function can be defined such that intensity values near 0 and 255, e.g., intensity values greater than T₁ or less than T₂, where T₁ and T₂ are respectively near 255 and 0, are not used. As a result, jumping between 0 and 255 can be eliminated, thereby also eliminating the appearance of “salt and pepper” artifacts. The piecewise linear mapping function can then be defined linearly for other intensity regions, e.g. intensity values between T₁ and T₂. For example, it can be seen that Equation (4) is a piecewise linear example of using Equation (2) in such a manner. In another example, intensity values in a piecewise linear mapping function can be partitioned into finer regions, thereby further reducing visual artifacts as the jumping gap between T₁ and T₂ is reduced.

In accordance with another aspect, an alternative mapping approach is illustrated by circular representation 306. In the alternative mapping approach illustrated by circle 306, intensity values on the circle 306 are located such that neighboring values vary only slightly in intensity and that jumping between 0 and 255 is prevented. However, such a method may also limit the visibility of a watermark in an image. For example, as illustrated by circle 306, odd pixel values are located in the left half of the circle in ascending order in the clockwise direction while even pixel values are located in the right half of the circle in descending order in the clockwise direction. Accordingly, pixels in a smooth image region may increase or decrease based on the alternative mapping function illustrated by circle 306 depending on whether the pixel has an even or odd intensity.

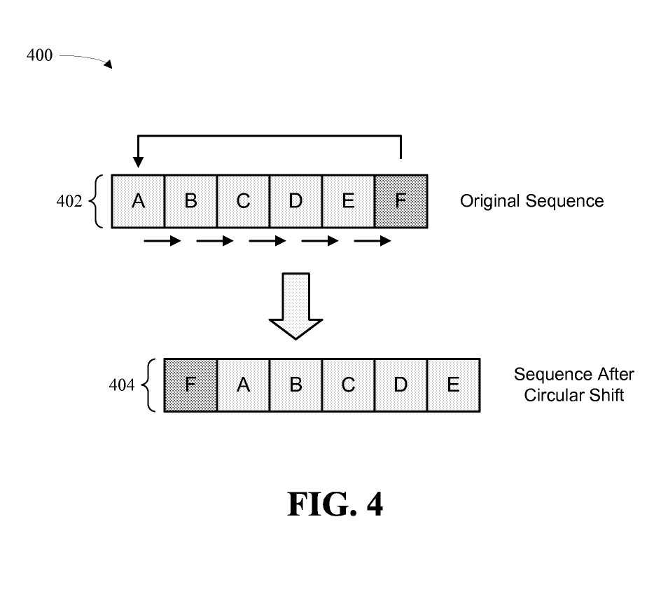

Turning briefly to FIG. 4, an example circular shifting operation 400 (e.g., a circular shifting operation g that can be performed by a position shift component 204 at a watermarking component 12) in accordance with an aspect of the present invention is illustrated. More particularly, FIG. 4 illustrates a circular shifting operation 400 with a shift distance of one pixel performed on an original sequence 402 of six pixels, denoted as A-F. To perform the shifting operation 400, the rightmost pixel, denoted as F, is moved to the leftmost position in the pixel sequence while the remaining pixels are shifted one pixel to the right, resulting in sequence 404. The movement of each pixel during the circular shifting operation 400 is illustrated with arrows at the original sequence 402.

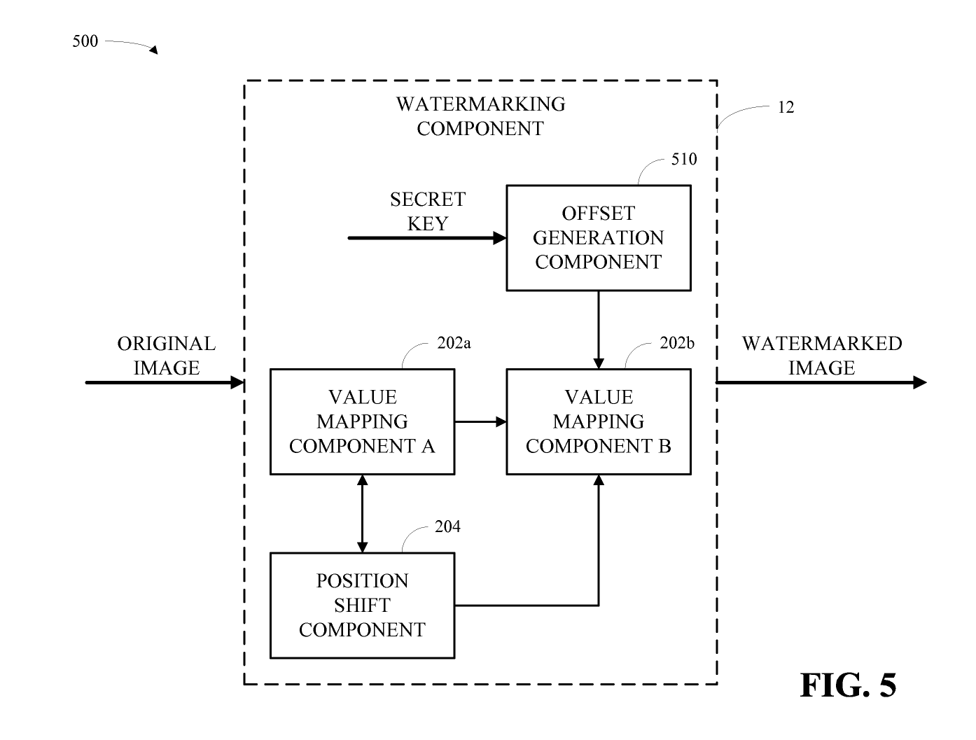

Referring now to FIG. 5, a block diagram of a system 500 for securely embedding a visible watermark in an image in accordance with an aspect of the present invention is illustrated. In one example, system 500 includes a watermarking component 12 that can embed a watermark in an original host image to create a watermarked image. To enhance the security of the watermark, the watermarking component 12 in system 500 can further embed a watermark in an original host image based on a secret key k. The secret key k can be used, for example, by an offset generation component 510 to generate integer offsets that can then be used by the watermarking component 12 to embed a watermark. Once an image is watermarked, it may then be capable of complete watermark extraction and reconstruction only upon knowledge of the secret key k. In one example, the secret key k and the offsets generated therefrom can be independent of the content of any given host image, which facilitates enhanced security for images watermarked using the watermarking component 12. By way of non-limiting example, such an application can be used by law enforcement agencies to secure photographic evidence and to prohibit tampering therewith prior to a trial or other proceeding at which the evidence will be presented.

In accordance with one aspect, a watermark can be initially embedded into an original host image using a value mapping component 202a and a position shift component 204 in a similar manner to the watermarking component 12 in system 200. In order to enhance the security of the PVMA and/or PPSA utilized in the initial watermarking, the offset generation component 510 can generate integers for respective pixels in the host image based on a secret key k. The integers generated by the offset generation component 510 can then be used by a value mapping component 202b for supplemental value mapping, wherein the watermark can be securely embedded in the host image using a linear or piecewise linear mapping function. For example, based on the value mapping function in Equation (3), value mapping can be conducted using an offset n provided by the offset generation component 510 as follows:

$$\begin{matrix}\begin{matrix}f ( t , c , n ) = ( t + c + n ) mod 256 \\ = ( ( t + c ) mod 256 + n ) mod 256 \\ = f ( f ( t , c ) , n )\end{matrix} & ( 8 )\end{matrix}$$

Accordingly, the value mapping function ƒ(t, c) can be computed by a first value mapping component 202a, and the resulting transformation can be utilized to compute the second value mapping function ƒ(ƒ(t, c), n) at a second value mapping component 202b. Alternatively, while a first value mapping component 202a and a second value mapping component 202b are illustrated in system 500, it should be appreciated that a single value mapping component 202 can perform value mapping on a single host image at multiple stages. As another alternative, an offset can be initially provided by the offset generation component 510 to a single value mapping component 202 to facilitate single-stage computation of ƒ(ƒ(t, c), n) for watermarking the host image using the secret key k.

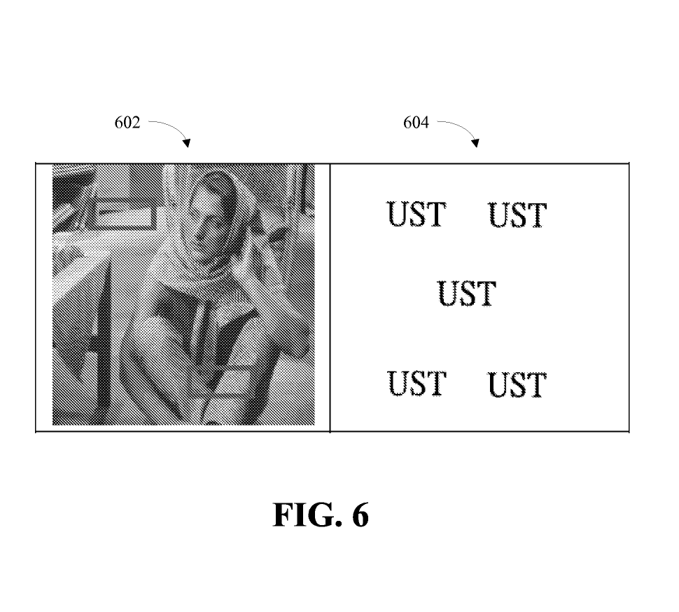

Turning briefly to FIG. 6, an example binary watermark 604 and an image 602 in which the watermark can be embedded in accordance with an aspect of the present invention are illustrated. The image 602 is the standard Barbara test bitmap image in grayscale format, and the watermark 604 is a binary watermark illustrated as a black and white image, such that, for example, W(x, y)=0 in locations (x, y) of the watermark 604 illustrated as black pixels and W(x, y)=1 in locations (x, y) of the watermark 604 illustrated as white pixels. It can also be observed that the watermark 604 includes a logo that is present in multiple locations and in the center of the image; such a watermark placement strategy can be utilized to prevent cropping of the logo from the image 602. Additionally, boxes in the upper-left and lower-right corners of the image 602 are used to illustrate the image locations corresponding to the upper-left and lower-right logos in the watermark 604. As can be seen in image 602, the upper-left boxed region is smooth with low variance while the lower-right boxed region is textured with high variance.

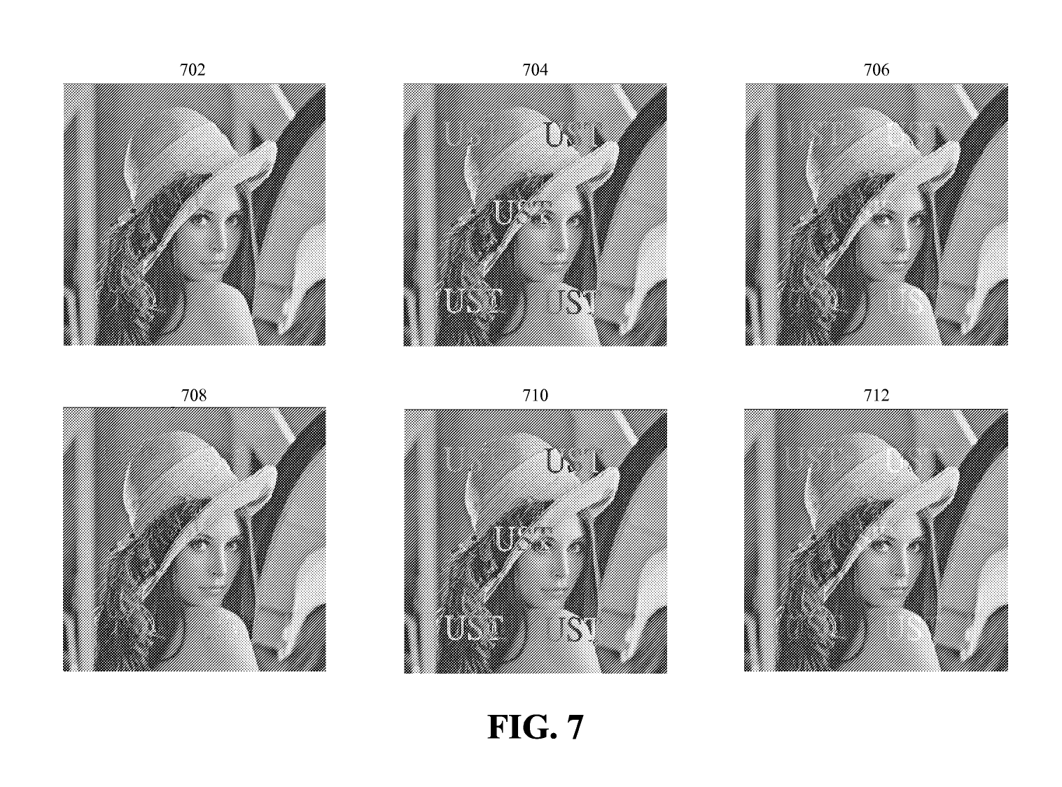

Referring to FIG. 7, a host image 702 and example watermarked images 704-712 generated therefrom in accordance with an aspect of the present invention are illustrated. The standard Lena test bitmap image in grayscale format is used in images 702-712, and the watermark embedded in watermarked images 704-712 is the substantially the same as watermark 604.

Various lossless watermarking techniques in accordance with various aspects disclosed herein were employed during experimentation on different test images, including the Barbara test image 602, the Lena test image 702, and the standard Baboon, F16, Fishing Boat, Pentagon, and Peppers bitmap test images in grayscale format. Results obtained using these techniques are detailed in Table 1 below:

TABLE 1
PSNR and WPSNR data from test images for various watermarking techniques.

| | PVMA Using | | PVMA Using | | PVMA Using | | PPSA Using | | PPSA Using | |
|---|---|---|---|---|---|---|---|---|---|---|
| | Equation (2) | | Equation (3) | | Alt. Mapping | | Equation (2) | | Equation (3) | |
| Images | PSNR | WPSNR | PSNR | WPSNR | PSNR | WPSNR | PSNR | WPSNR | PSNR | WPSNR |
| Lena | 22.66 | 28.87 | 33.10 | 39.55 | 33.69 | 48.89 | 22.81 | 28.97 | 31.73 | 38.99 |
| Barbara | 22.73 | 29.20 | 33.63 | 39.75 | 33.70 | 48.72 | 23.08 | 29.29 | 30.77 | 39.25 |
| Baboon | 24.53 | 31.93 | 33.69 | 39.74 | 33.70 | 48.65 | 25.11 | 32.11 | 30.61 | 39.25 |
| F16 | 27.39 | 34.15 | 33.54 | 39.77 | 33.69 | 48.29 | 27.84 | 34.31 | 32.13 | 39.52 |
| Fishingboat | 20.96 | 27.07 | 33.69 | 39.74 | 33.69 | 48.99 | 21.01 | 27.11 | 32.73 | 39.47 |
| Pentagon | 26.24 | 32.59 | 32.73 | 39.69 | 33.70 | 48.62 | 26.51 | 32.76 | 31.94 | 39.42 |
| Peppers | 23.06 | 29.18 | 33.69 | 39.74 | 33.69 | 49.11 | 23.15 | 29.24 | 32.73 | 39.52 |

Specifically, Table 1 illustrates distortion introduced into each test image by various watermarking techniques described herein. From left to right, Table 1 illustrates the PVMA used alone pursuant to Equation (2), the PVMA used alone pursuant to Equation (3), the PVMA used alone pursuant to the alternative mapping method illustrated by circular representation 306, the PVMA used pursuant to Equation (2) and in conjunction with the PPSA, and the PVMA used pursuant to Equation (3) and in conjunction with the PPSA. In one example, the PVMA can be performed by a value mapping component 202 and the PPSA can be performed by a position shift component 204. The offset constant c in Equation (3) is set to 30 and the offset constant c used for the alternative mapping method is set to 15, resulting in an overall pixel value change of approximately 30 in both cases. Peak signal-to-noise ratios (PSNRs) and weighted PSNRs (WPSNRs) between the watermarked images and the original host images are used in Table 1 to illustrate the visual quality of the watermarked images. To compute the PSNR data, the mean square error (MSE) variation between the original host images and their corresponding watermarked images is used. To compute the WSPNR data, the MSE between the host images and their corresponding watermarked images were weighted based on the contrast sensitive function (CSF) of the human visual system.

As illustrated in FIG. 7, image 704 was created using the PVMA used alone pursuant to Equation (2), image 706 was created using the PVMA used alone pursuant to Equation (3), image 708 was created using the PVMA used alone pursuant to the alternative mapping method illustrated by circular representation 306, image 710 was created using the PVMA used pursuant to Equation (2) and in conjunction with the PPSA, and image 712 was created using the PVMA used pursuant to Equation (3) and in conjunction with the PPSA. As can be observed from Table 1, the PSNR and WPSNR data are consistently the smallest for the PVMA performed using Equation (2) with and without the PPSA. This is due to the fact that, as respectively illustrated by watermarked images 704 and 710, large amounts of distortion are introduced for small and large pixel values pursuant to those techniques. As further illustrated by images 704 and 710, the large amount of distortion introduced using Equation (2) also make the watermark more visible. Additionally, it can be observed from Table 1 that the PSNR and WPSNR data are consistently the highest for the PVMA performed using the alternative mapping method. As illustrated by image 708, this results in less distortion due to the fact that jumping between 0 and 255 is prevented and, as a result, a less visible watermark.

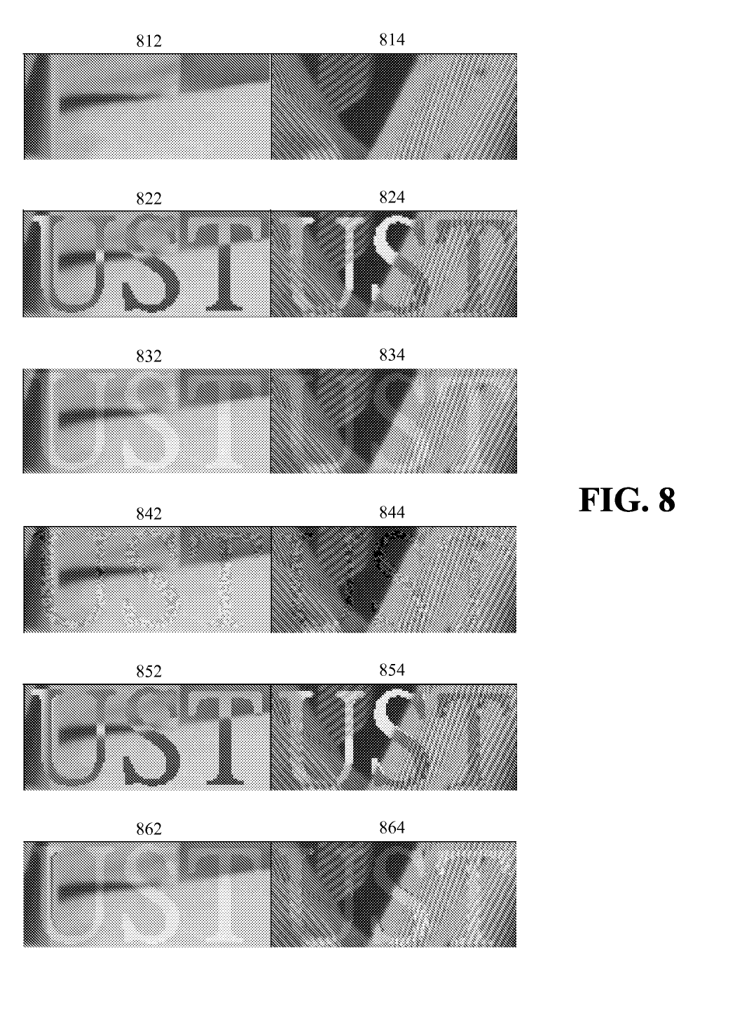

Turning now to FIG. 8, detailed portions of the Barbara test image 602 are illustrated in accordance with various aspects of the present invention. The images on the left side of FIG. 8, denoted 812, 822, 832, 842, 852, and 862, depict the top-left boxed region in image 602, while the images on the right side of FIG. 8, denoted 814, 824, 834, 844, 854, and 864, depict the bottom-right boxed region in image 602. Images 812-814 illustrate the original Barbara host image while images 822-864 illustrate watermarked images pursuant to the same respective watermarking techniques illustrated in FIG. 7 and Table 1. As can be observed from FIG. 8, the “UST” logo in the watermarked image 864, which corresponds to the bottom-right portion of the Barbara test image watermarked by the PVMA using Equation (3) and the PPSA, is more visible than in the watermarked image 834, which corresponds to the bottom-right portion of the Barbara test image watermarked by only the PVMA using Equation (3). This is due to the circular pixel shift performed pursuant to the PPSA in image 864, which can enhance the visibility of a watermark in a textured image region. In accordance with one aspect, the PVMA requires less complexity than the PPSA. However, as the PVMA may treat low-variance and high-variance image regions similarly, the PPSA can be used to supplement the PVMA in high-variance or textured image regions.

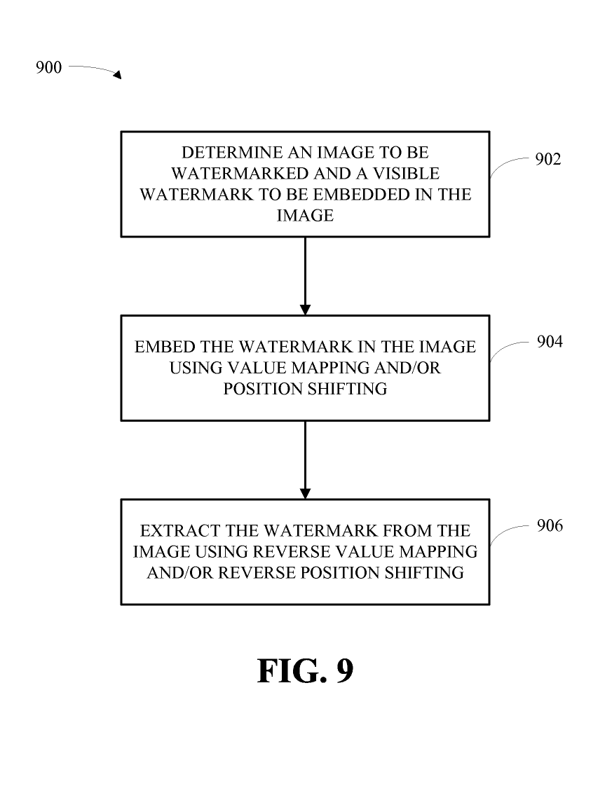

Referring now to FIGS. 9-11, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

Furthermore, the invention may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 9, a method 900 of embedding and extracting a visible watermark in accordance with an aspect of the present invention is illustrated. At 902, an image to be watermarked and a visible watermark to be embedded in the image are determined (e.g., by a watermarking component 12 and/or a distributing device 10). At 904, the watermark is embedded in the image using value mapping (e.g., via a PVMA performed by a value mapping component 202) and/or position shifting (e.g., via a PPSA performed by a position shift component 204). At 906, the watermark is extracted (e.g., by an extraction component 22 at a receiving device 20) using reverse value mapping and/or reverse pixel shifting.

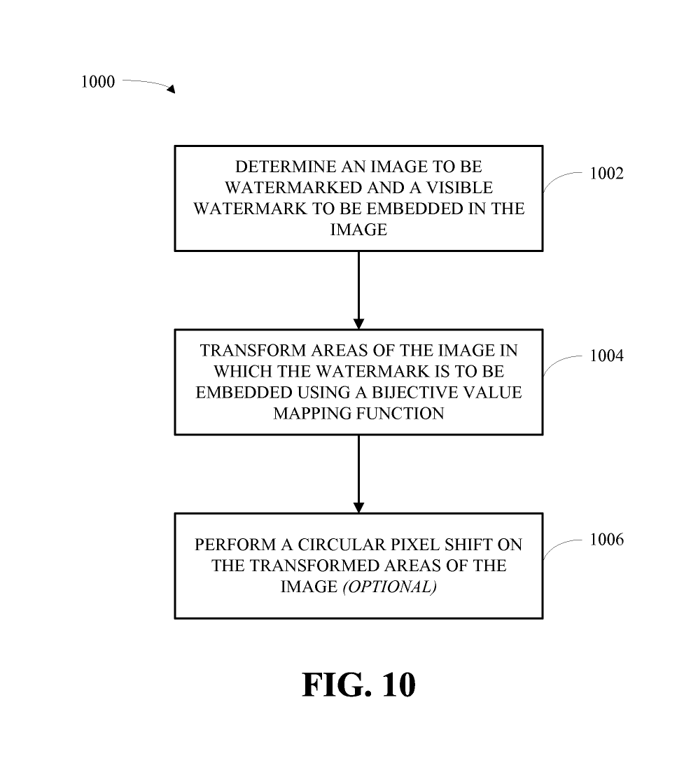

Referring now to FIG. 10, a method 1000 of embedding a visible watermark in an image in accordance with an aspect of the present invention is illustrated. At 1002, an image to be watermarked and a visible watermark to be embedded in the image are determined. At 1004, areas of the image in which the watermark is to be embedded are transformed (e.g., by a value mapping component at a watermarking component 12) using a bijective value mapping function. Method 1000 may then optionally proceed to 1006, where a circular pixel shift is performed on the transformed areas of the image (e.g., by a position shift component 204 at a watermarking component 12).

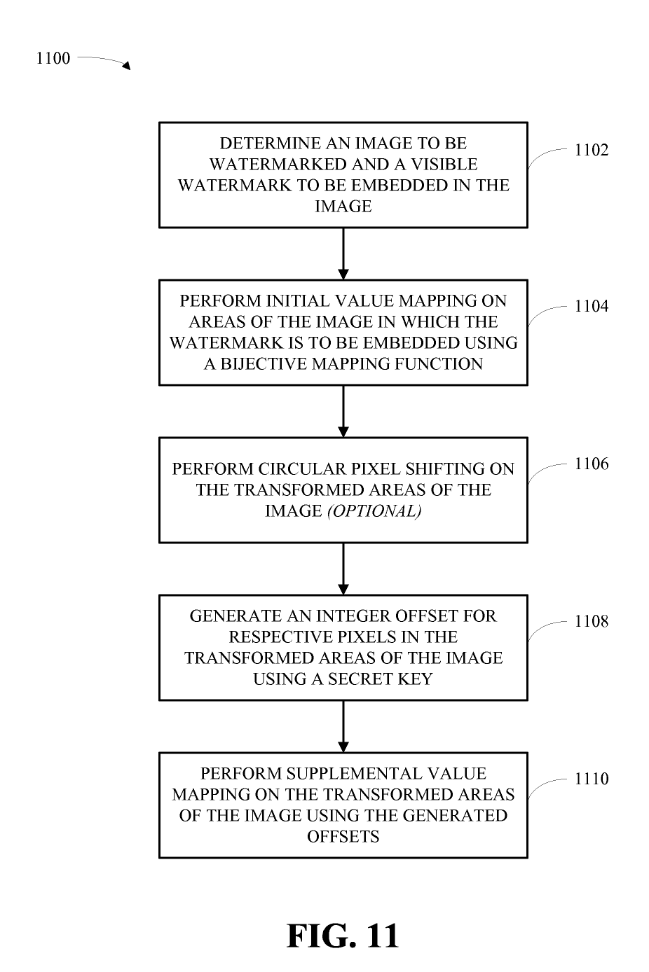

Turning to FIG. 11, a method 1100 of securely watermarking an image in accordance with an aspect of the present invention is illustrated. At 1102, an image to be watermarked and a visible watermark to be embedded in the image are determined. At 1104, initial value mapping is performed on areas of the image in which the watermark is to be embedded using a bijective mapping function. Method 1100 may then optionally proceed to 1106, where a circular pixel shift is performed on the transformed areas of the image. After 1104 or 1106, method 1100 can proceed to 1108, where an integer offset for respective pixels in the transformed areas of the image are generated (e.g., by an offset generation component 510) using a secret key. At 1110, supplemental value mapping is then performed on the transformed areas of the image using the generated offsets.

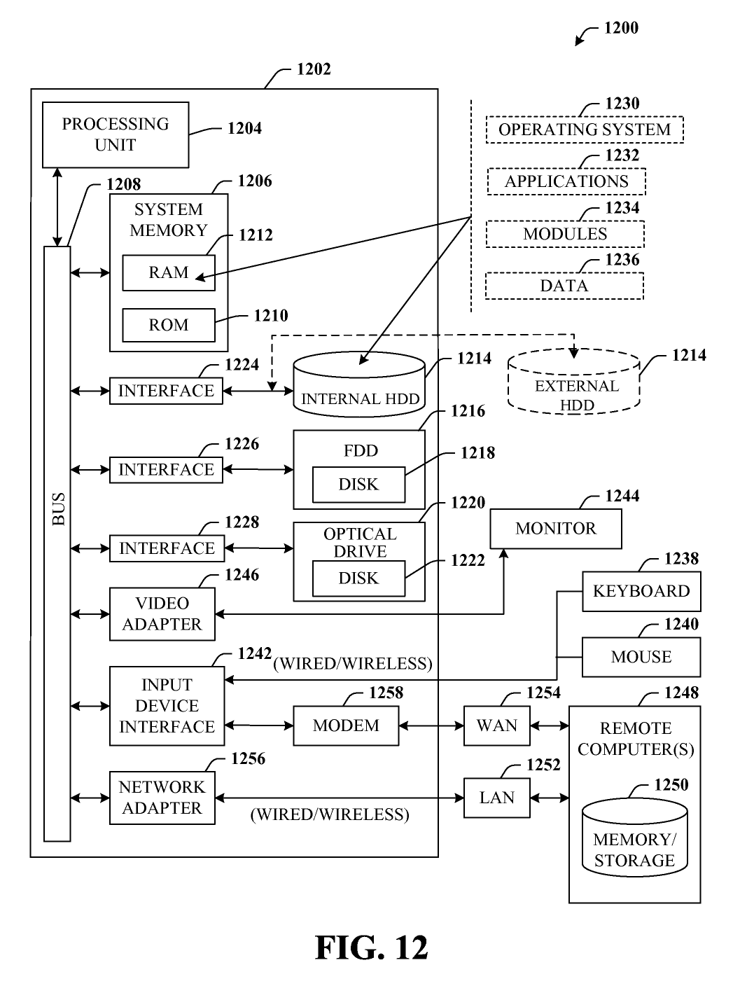

In order to provide additional context for various aspects of the subject invention, FIG. 12 and the following discussion are intended to provide a brief, general description of a suitable computing environment 1200 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software. Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the example computing environment 1200 includes a computer 1202, the computer 1202 including a processing unit 1204, a system memory 1206 and a system bus 1208. The system bus 1208 couples to system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA) that may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE-1394 interface technologies. Other external drive connection technologies are within contemplation of the subject invention.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the invention can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, a serial port, an IEEE-1394 port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as remote computer(s) 1248. A remote computer 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, telephone, etc. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band). Thus, networks using Wi-Fi wireless technology can provide real-world performance similar to a 12 BaseT wired Ethernet network.

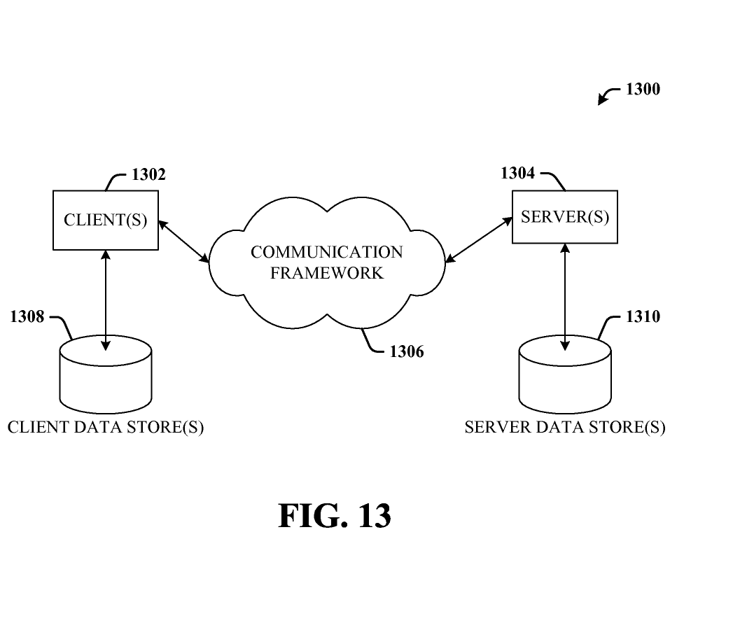

Referring now to FIG. 13, a block diagram of an example networked computing environment in which the present invention may function is illustrated. The system 1300 includes one or more client(s) 1302. The client(s) 1302 can be hardware and/or software (e.g., threads, processes, computing devices). The system 1300 also includes one or more server(s) 1304. The server(s) 1304 can also be hardware and/or software (e.g., threads, processes, computing devices). One possible communication between a client 1302 and a server 1304 can be in the form of a data packet adapted to be transmitted between two or more computer processes. The data packet may include a video signal and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302. Similarly, the server(s) 1304 are operatively connected to one or more server data store(s) 1310 that can be employed to store information local to the servers 1304.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A system for embedding a visible watermark in an image, comprising:
an input component that receives a host image; and
a watermarking component that embeds a visible binary watermark in the host image according to one or more lossless watermarking algorithms.

2. The system of claim 1, wherein the watermarking component comprises a value mapping component that performs a Pixel Value Mapping Algorithm at least in part by transforming respective intensities of pixels of the host image to which the visible binary watermark is to be embedded pursuant to a bijective value mapping function.

3. The system of claim 2, wherein the bijective value mapping function used by the value mapping component is a linear function.

4. The system of claim 3, wherein the linear function is offset by a user-defined constant.

5. The system of claim 2, wherein the bijective value mapping function used by the value mapping component is a piecewise linear function.

6. The system of claim 2, wherein the bijective value mapping function used by the value mapping component is an alternating value mapping function that increases respective intensities of pixels having even-valued intensities and decreases respective intensities of pixels having odd-valued intensities.

7. The system of claim 2, wherein the watermarking component further comprises a position shift component that executes a Pixel Position Shift Algorithm at least in part by circularly shifting respective pixels in the host image that are transformed by the value mapping component.

8. The system of claim 2, wherein the watermarking component further comprises an offset generation component that generates respective integer offsets for pixels in the host image to be transformed by the value mapping component based at least in part on a secret key.

9. The system of claim 8, wherein the bijective value mapping function utilized by the value mapping component is offset for the respective pixels in the host image to be transformed based on the integer offsets generated by the offset generation component for the respective pixels.

10. The system of claim 1, further comprising a receiving device that receives an image watermarked by the watermarking component and perfectly reconstructs the host image from the received image by extracting the watermark from the received image.

11. A method of watermarking a host image, comprising:
receiving a host image to which a visible watermark is to be embedded; and
embedding the watermark in the host image at least in part by transforming intensities of respective areas of the host image corresponding to the watermark based on a bijective pixel value mapping function.

12. The method of claim 11, wherein the embedding includes embedding the watermark based on a linear function that spans substantially all of a possible intensity spectrum for the host image.

13. The method of claim 11, wherein the embedding includes embedding the watermark based on a piecewise linear function that spans a subset of a possible intensity spectrum for the host image.

14. The method of claim 11, wherein the embedding the watermark includes performing a circular pixel shift on the respective areas of the host image corresponding to the watermark.

15. The method of claim 11, further comprising generating integer values for respective pixels in the areas of the host image corresponding to the watermark based on a key, wherein the embedding the watermark includes transforming intensities of the respective pixels based on the bijective pixel value mapping function and the generated integer values for the respective pixels.

16. The method of claim 15, wherein the transforming intensities of the respective pixels includes:
performing an initial value mapping of the intensities of the respective pixels based on the bijective pixel value mapping function; and
performing a supplemental value mapping of the intensities of the respective pixels based on the bijective pixel value mapping function and the generated integer values for the respective pixels.

17. The method of claim 11, further comprising extracting the watermark from the host image to perfectly reconstruct the host image.

18. A computer-readable medium having stored thereon computer-executable instructions for performing the method of claim 11.

19. A system that facilitates lossless visible watermarking of an image, comprising:
means for receiving an image to be watermarked;
means for identifying a visible binary watermark to be embedded in the image; and
means for embedding the watermark in the image at least in part by transforming areas of the image in which the watermark is to be embedded using a bijective value mapping function.

20. The system of claim 19, wherein the means for embedding the watermark includes means for performing a circular pixel shift on the transformed areas of the image.
